(19) United States
(12) Patent Application Publication
(10) Pub. No.: US 2012/0132591 A1
(43) Pub. Date: May 31, 2012

(54) METHOD FOR DESALINATING WATER USING ZEOLITE MEMBRANE

(75) Inventors: Guangshan Zhu, Changchun (CN); Shilun Qiu, Changchun (CN); He Qiu, Trenton, NJ (US); Bing Zhou, Cranbury, NJ (US)

(73) Assignee: Headwaters Technology Innovation, LLC, Lawrenceville, NJ (US)

(21) Appl. No.: 13/365,786

(22) Filed: Feb. 3, 2012

Related U.S. Application Data
(62) Division of application No. 12/429,899, filed on Apr. 24, 2009.

(51) Int. Cl. C02F 1/44

(52) U.S. Cl. 210/653

(57) ABSTRACT

A novel zeolite membrane is manufactured using zeolite seeds that are deposited on a support material. The seeds are then further grown in a secondary growth step to form a membrane with inter-grown particles. The pore size of the zeolite membrane is in a range between 3 angstrom and 8 angstrom, which allows water to flow through the membrane at a relatively high flux rate while excluding dissolved ions. The novel zeolite membrane is surprisingly efficient for desalinating sea water using reverse osmosis. The zeolite membrane is capable of high rates of water flux rate and high percentage of ion rejection.

### CROSS REFERENCE TO RELATED APPLICATION

This application is a division of copending U.S. application Ser. No. 12/429,899, filed Apr. 24, 2009, the disclosure of which is incorporated herein in its entirety.

### BACKGROUND OF THE INVENTION

1. The Field of the Invention

The present invention relates to zeolite membranes and methods for making and using the zeolite membranes for water desalination.

2. The Relevant Technology

The supply of fresh water continues to be of great concern for a significant percentage of the world's people. Natural fresh water resources are limited and notoriously variable. In some parts of the world, the lack of fresh water and/or the inconsistent supply of fresh water have led to development of large-scale water desalination plants that remove the salt from sea water to produce fresh water. Large-scale desalination typically requires large amounts of energy as well as specialized, expensive infrastructure, making it very costly compared to the use of fresh water from rivers or groundwater.

Large-scale desalination projects often use reverse osmosis to remove the salt from the sea water or brackish water. Sea water reverse osmosis is carried out by using pressure to force sea water through a membrane. The membrane retains the solute (i.e., the salt) on one side and allows the pure solvent (i.e., the water) to pass through the membrane to the other side. Thus, reverse osmosis is the process of forcing a solvent from a region of high solute concentration through a membrane to a region of low solute concentration by applying a pressure in excess of the osmotic pressure. Reverse osmosis is the reverse of osmosis, which is the natural movement of solvent from an area of low solute concentration, through a membrane, to an area of high solute concentration when no external pressure is applied.

The membranes currently used for reverse osmosis have a dense barrier layer in a polymer matrix where water-salt separation occurs. In most cases the membrane is designed to allow only water to pass through the dense layer while preventing the passage of salt ions. This process typically requires pressure to be exerted on the high concentration side of the membrane, usually 4000-7000 kPA (600-1000 psi) for seawater, to overcome the natural osmotic pressure, which is typically around 2400 kPa (350 psi).

### BRIEF SUMMARY OF THE INVENTION

The present invention relates to novel zeolite membranes that are surprisingly efficient for desalinating sea water using reverse osmosis. The zeolite membranes are capable of high rates of water flux and high percentage of ion rejection. In addition, the zeolite membranes withstand high temperatures and chemically harsh conditions and have a relative long useful lifetime.

The zeolite membranes of the present invention are manufactured using zeolite seeds that are deposited on a support material. The seeds are then further grown in a secondary growth step to form a membrane with inter-grown particles. The pore size and thickness of the membrane are selected to yield a zeolite membrane that is suitable for desalination of water. In particular, the thickness of the zeolite portion of the membrane and the pore size of the zeolite crystals are selected to allow water to flow through the membrane at a relatively high flux rate while excluding dissolved ions (e.g., sodium).

To achieve a relatively high flux rate for water, the zeolite membranes have a pore diameter that is in a range from about 3 angstrom to 8 angstrom, more preferably 4 angstrom to 7 angstrom, and most preferably from about 4.5 angstrom to 6 angstrom. This pore diameter allows water to flow at a relatively high flux, while preventing dissolved ions (in water) from flowing through the pores.

Cations and other atoms found in seawater are typically smaller than water on an atomic scale. However, when dissolved in water, the solvated ions bond with water to form an ion-water complex (i.e., dissolved ions are not free from the solvent). The ion-water complex is substantially larger than unbound water. For example, [Na(H₂O)ₓ]⁺ has an effective size of about 0.8-1.0 nm, which is much larger than water. The zeolite membranes selectively filter dissolved ions in water by providing a pore size that allows relatively high flux rates for water while selectively retaining dissolved ions.

The thickness of the zeolite layer also facilitates high flux. In one embodiment, the thickness of the zeolite layer is in a range from about 1 μm to about 300 μm, which can be achieved using zeolite seed particles as described below.

One embodiment of the invention includes a method for making a zeolite membrane suitable for desalinating water using reverse osmosis. The method includes providing a support material (e.g., glass frit) and then depositing a plurality of seed particles on the support material to form an intermediate supported zeolite. The seed particles of the intermediate are a zeolite crystal with a pore diameter in a range from about 3-8 angstrom. The intermediate supported zeolite is combined with a zeolite reaction mixture and the seed particles are further grown. The seed particles are allowed to grow into one another, thereby forming a zeolite membrane.

In a preferred embodiment, the thickness of the zeolite layer of the membrane is maintained within a desired range that provides high flux rates while still achieving the desired selectivity for ion rejection. In one embodiment, the thickness of the zeolite layer can be in a range from about 1 μm to about 300 μm, more preferably about 10 μm to about 200, and most preferably in a range from about 15 μm to about 100 μm. The thickness of the zeolite layer can generally be controlled by providing a desired density of seed crystals on the support and carrying out the secondary growth of the seed particles until the desired thickness is reached. The thickness of the zeolite membrane (i.e., including the support and the zeolite layer) can be in a range from about 1 mm to about 20 mm, more preferably about 2 mm to about 10 mm and most preferably about 3 mm to about 5 mm.

The zeolite membranes of the present invention are used to desalinate brine using reverse osmosis. Reverse osmosis is performed by placing brine on one side of the zeolite membrane of the present invention and applying a pressure difference across the membrane. The pressure difference causes water to permeate through the membrane. However, due to the size exclusion of the zeolite structure, dissolved ions are rejected by the membrane (i.e., retained on the brine side of the membrane). The amount of pressure can depend on the dissolved ion concentration in the saline water and can be in excess of the osmotic pressure across the membrane. For example, for ocean water with a salt concentration of about 3.5% by weight, the force across the membrane (e.g., a vacuum pressure) can be in a range from about 20 kPa to about 20 MPa. In an alternative embodiment, the pressure across the membrane (i.e., negative or positive pressure) is at least about 200 psi, alternatively at least about 400 psi, or at least about 800 psi. The ability to use low pressure and achieve relativity high flux rates is advantageous for economically desalinating water. However, high pressure can be advantageous for achieving very high flow rates.

These and other features of the present invention will become more fully apparent from the following description and appended claims.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a schematic representation of an example system for performing reverse osmosis using a zeolite membrane according to one embodiment of the invention;

FIGS. 2A-2C are high resolution TEM images of a zeolite membrane manufactured according to one embodiment of the invention;

FIGS. 3A-3C are high resolution TEM images of a zeolite membrane manufactured according to another embodiment of the invention; and

FIG. 4 is a graph showing the relationship between water flux and pressure.

### DETAILED DESCRIPTION OF EXAMPLE EMBODIMENTS

The present invention relates to a novel zeolite membrane that efficiently desalinates water by reverse osmosis. The zeolite membrane is capable of surprisingly high water flux rates and surprisingly high percentages of ion rejection. The zeolite membranes are manufactured using zeolite seeds that are deposited on a support material. The seeds are then further grown in a secondary growth step to form a membrane with inter-grown particles. The pore size of the zeolite membrane is in a range between 3 angstrom and 8 angstrom. The zeolite membranes are believed to facilitate desalination by allowing the water to flow through the membrane while excluding hydrated ions based on size (i.e., size exclusion). The zeolite membranes of the invention are manufactured from a support material, zeolite seed crystals, a zeolite reaction mixture, and solvents.

### I. Components for Manufacturing Membranes

A. Support Material

The support material provides a surface for depositing the seed crystals, which are then grown to form the membrane. The support material is typically sufficiently porous so as to have little or no restriction on the flux of water through the membrane. The support material can be any porous inorganic material upon which the seed crystals can be deposited. The support materials preferably have a surface area in a range from about 1 cm² to about 200 cm², more preferably in a range from about 4 cm² to about 100 cm². In one embodiment, the pore diameter of the support is in a range from about 1 μm to about 100 μm, more preferably about 5 μm to about 60 μm. Examples of suitable support materials include glass frit, stainless-steel-net, a-Al₂O₃, and copper net. The thickness of the support can be any thickness that provides a desired strength without significantly reducing the flux. For example, the thickness of the support can be in a range from about 0.5 mm to about 500 mm, more preferably about 1 mm to about 200 mm.

B. Zeolite Seed Crystals

The zeolite seed crystals are small crystalline particles of zeolite. The zeolite seed crystals are made of a zeolite material that can serve as a template for secondary growth to form the zeolite membranes of the invention. Any zeolite can be used so long as the zeolite has the desired micro-structure and chemical composition to achieve the desired flux and ion rejection rates suitable for water desalination.

Typically, zeolites have as a fundamental unit consisting of a tetrahedral complex of Si⁴⁺ and Al³⁺ in tetrahedral coordination with four oxygen atoms. The tetrahedral units of (SiO₄) and (AlO₄)⁻ are linked to each other by shared oxygen atoms to form three-dimensional networks. The networks produce channels and cavities of molecular dimensions. Water molecules and charged compensating cations are found inside the channels and cavities of the zeolitic materials. The various possible linkages between the primary tetrahedral structure determine the different zeolite structures, which can have different surface areas, pore size, and/or pore shape. Besides silicon and aluminum, other atoms can be incorporated into lattice positions.

The various stoichiometries of SiO₂, Al₂O₃, and other oxides lead to various zeolites. One zeolite that is of interest for water desalination is Zeolite Socony Mobil-5 (SM-5), or ZSM-5. The ZSM-5 zeolite is a supported, MFI-type zeolite. The final structure of a ZSM-5 zeolite has a lattice configuration that includes the basic functional groups of Al₂O₃, SiO₂, and Na₂O. Other zeolite materials suitable for use with the present invention include zeolite A, zeolite P, and zeolite SPO₃₄.

In some cases, the molar ratio of SiO₂/Al.₂O₃ is an indicator of the usefulness of the properties that the zeolite will possess. In one embodiment of the invention, the zeolites have a molar ratio of SiO₂/Al.₂O₃ in a range from about 10 to about 500, more preferably about 50 to about 400, and most preferably about 100 to about 300. Increasing the SiO₂/Al.₂O₃ ratio increases the flux while simultaneously decreasing the cation rejection rate. Conversely, decreasing the SiO₂/Al.₂O₃ ratio decreases flux and increases cation rejection.

During the manufacture of the zeolite membranes, the seed particles provide a template for crystal growth. Thus the zeolite seed particles should have a crystal structure and pore size suitable for providing the desired crystal properties in the zeolite membrane. The zeolite seed particles can have a pore size in a range from about 3 angstrom to about 8 angstrom, more preferably about 4 angstrom to about 7 angstrom, and most preferably about 4.5 angstrom to about 6 angstrom.

The zeolite seed particles are provided in a size that facilitates suspension in a solvent and/or deposition of the particle onto the support material. In one embodiment, the zeolite seed particles have a particle size in a range from about 20 nm to about 500 nm, more preferably about 50 nm to about 300 nm.

The zeolite seed particles can be manufactured using any technique that imparts the desired chemical composition, pore size, and/or particle size needed for depositing the seed particles on a support material and carrying out a secondary growth to yield the zeolite membrane. In general, the seed crystals are manufactured from the same or similar components as those used to carry out the secondary growth (i.e., the reaction mixture).

C. Zeolite Reaction Mixture

The zeolite membrane is grown from a zeolite reaction mixture. The zeolite reaction mixture includes the components needed to enlarge the zeolite seed particles. Typically, the reaction mixture is selected to grow the same or very similar zeolite as the zeolite seed crystal. For example, where the zeolite seed crystals include one or more of silicalite-1, ZSM-5, zeolite A, zeolite P, or zeolite SPO₃₄, the reaction mixture will be zeolite precursors that yield the same or similar type of zeolite.

In one embodiment, the zeolite reaction mixture can include one or more of a base such as, but not limited to, sodium hydroxide, a templating agent such as, but not limited to, tetra-n-propylammonium hydroxide (TPAOH), a silica source such as, but not limited to, silicic acid tetraethyl ester (TEOS), and an aluminum source such as, but not limited to, aluminum sulfate octadecahydrate (Al₂(SO₄)₃.18H₂O and a solvent such as deionized water.

In one embodiment, the reaction mixture includes precursors for making a ZSM-5 material. For example, ZSM-5 can be manufacture using the following formula: 0.1NaOH/1.62TPAOH/6.1TEOS/552H₂O/0.022-0.11Al₂(SO₄)₃.18H₂O. The following is an example of a suitable reaction mixture for making Silicalite-1: 0.32 TPAOH/1.0 TEOS/165 H₂O. Those skilled in the art are familiar with suitable reaction mixtures for growing the zeolites materials useful in making the zeolite membranes of the invention.

D. Solvents

In one embodiment of the invention, the zeolite seed crystals can be dispersed in a solvent to facilitate depositing the zeolite seed crystals on the support material. Any solvent or combination of solvents and/or dispersing agents compatible with the support material and the zeolite seed crystals can be used. Examples of solvents suitable for use in the present invention include water and/or alcohols such as ethanol or propanol.

### II. Methods for Manufacturing Zeolite Membranes

The zeolite membranes of the present invention are manufactured by carrying out all or a portion of the following steps: (i) providing a support material, (ii) forming a suspension of zeolite seed crystals, (iii) depositing the zeolite seed particles on the support material to form an intermediate supported zeolite, (iv) combining the intermediate supported zeolite with a zeolite reaction mixture and growing the seed crystals to form a zeolite membrane.

A. Forming an Intermediate Supported Zeolite

The intermediate supported zeolite is made by preparing a suspension comprising the zeolite seed particles, a solvent, and optional dispersing agents. In one embodiment, the suspension of seed particles is prepared by mixing together one or more types of zeolite seed particles and one or more solvents with a base such as NH₄OH to prevent agglomeration of the seed particles. The suspension of the zeolite seed particles can have a concentration in a range from about 5 g/l to about 100 g/l, more preferably about 10 g/l to about 40 g/l.

The intermediate supported zeolite is prepared by impregnating the support material with the suspension of zeolite particles. Typically the support material is washed and/or dried prior to use. The suspension of zeolite seed particles is contacted with the support material and the solvent from the suspension is allowed or caused to evaporate to leave the seed particles on the surface of the support material. The deposition of the seed particles can be carried out in one or more iterations to achieve a desired concentration of particles on the support material. In one embodiment, the concentration of seed particles on the support material is in a range from about 10 g/l to about 200 g/l, more preferably about 20 g/l to about 100 g/l.

Optionally, the support material can be wetted (e.g., using water or other suitable solvent) prior to contacting the support with the suspension of seed particles to control the location where the seed particles are deposited. The wetted support material has its pores filled with solvent, which makes it more difficult for the seed particles to be drawn in or diffused into the pores (as compared to a dry support). Wetting the support material results in less seed particles being used and ensures that the support material remains highly porous.

B. Growing Seed Particles to Form a Membrane

The zeolite membrane is formed by contacting the intermediate supported zeolite with a zeolite reaction mixture suitable for growing the zeolite seed particles to a larger size. Typically, the composition of the zeolite reaction mixture is selected to yield essentially the same zeolite material as the seed particles.

The zeolite seed particles are grown using conditions suitable for zeolite growth. In one embodiment, the zeolite growth is carried out at a temperature in a range from about 130° C. to about 180° C., more preferably about 140° C. to about 170° C. for about 1 day to about 5 days.

The secondary growth of the zeolite seed particles is allowed to continue growing until the crystals form a continuous membrane having inter-grown zeolite crystals. The continuous zeolite membrane typically has a thickness in a range from about 1 μm to about 300 μm, more preferably about 10 μm to about 200 μm, and most preferably in a range from about 15 μm to about 100 μm.

During the secondary growth of the seed particles, the seed particles serve as a template for the growth of the zeolite. The zeolite being formed during the secondary growth tends to form the same crystalline material as the seed crystals. Thus, by selecting the proper seed crystals and the proper reaction mixture, the pore size and chemical composition of the zeolite membrane can be closely controlled. By using seed crystals, a supported structure can be readily formed with the desired microcrystalline properties. The use of a support material facilitates the formation of relatively large membranes, which can be useful for large-scale water desalination.

By using seed particles that are evenly distributed on the surface of the support, complete membranes can be grown very thin. The thinness of the membranes of the present invention substantially contributes to the high flux rate that can be achieved for the membranes of the present invention. While the overall thickness of the zeolite membrane may be substantially larger than the zeolite layer, the additional thickness is due to the support material, which has a substantially larger pore diameter than the zeolite layer. Thus, the support can be made thick to give the membrane structural integrity, strength, and durability, without unnecessarily reducing the flux rate.

### III. Use of Membrane for Water Desalination

Zeolite membranes manufactured according to the invention can be used to desalinate saline water using reverse osmosis. The membrane can be used in any apparatus having two compartments or vessels separated by the membrane. Saline water, which includes dissolved ions and water, is brought into contact with the zeolite membrane and pressure is applied to the saline water so as to force the water through the membrane to carry out reverse osmosis. The pressure applied to the membrane can be a positive pressure on the saline side of the membrane or a negative pressure (i.e. a vacuum) on the permeate side of the membrane.

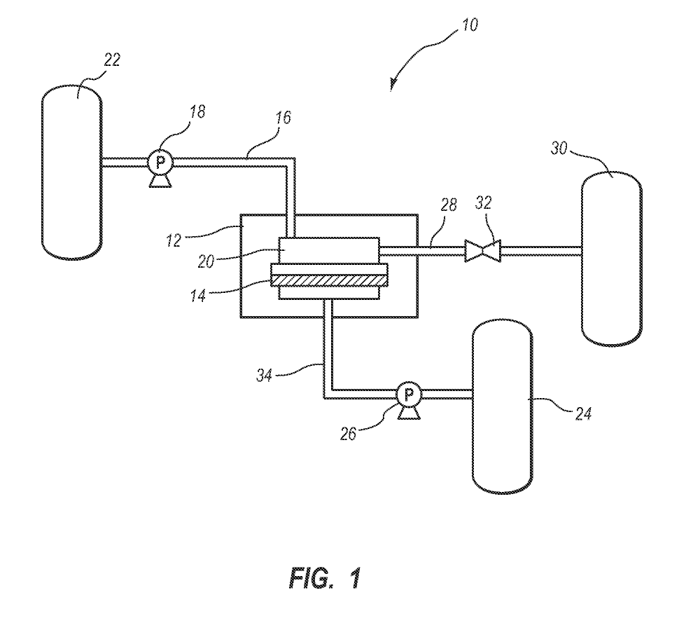

FIG. 1 is a schematic drawing of an apparatus suitable for carrying out reverse osmosis using the zeolite membranes. Apparatus 10 includes a membrane compartment 12 that includes a zeolite membrane 14 according to the invention. Membrane compartment 12 is coupled to a feed line 16. Pump 18 can be used to cause flow of saline water through feed line 16. Feed line 16 is coupled to a housing 20 that is in fluid communication with a brine reservoir 22. Brine reservoir 22 can be a storage vessel or a brine source, such as a body of sea water.

Membrane compartment 12 allows brine to be placed in contact with membrane 14. Water in the brine permeates through membrane 14 and produces purified water (i.e., permeate) that is collected in vessel 24. To increase the flux of water through membrane 14, additional pressure (i.e., in addition to gravity) can be applied to the membrane using pump 18. A valve 32 coupled to a discharge line 28 can be used to control pressure in line 16. Alternatively or in addition, a vacuum pump 26 can be placed on permeate line 34 to create a vacuum pressure on the permeate side of membrane 14. As water permeates through membrane 14, the concentration of dissolved ions in housing 20 increases and forms concentrated brine. Concentrated brine is removed from above membrane 14 through the discharge line 28 and can be temporarily stored in concentrated brine tank 30.

Surprisingly, reverse osmosis can be carried out with very little pressure. In one embodiment the reverse osmosis pressure can be provided by gravity. However, if rapid reverse osmosis is desired, the reverse osmosis can be carried out using pressure. In one embodiment, the pressure applied to the membrane 14 can be in a range from about 20 kPa to about 20 MPa. More preferably the pressure across the membrane can be in a range from about 1.0 MPa to 15 MPa or from about 2.0 MPa to about 10 MPa. In an alternative embodiment, the pressure across the membrane can be at least about 200 psi, alternatively at least about 400 psi, or at least about 800 psi.

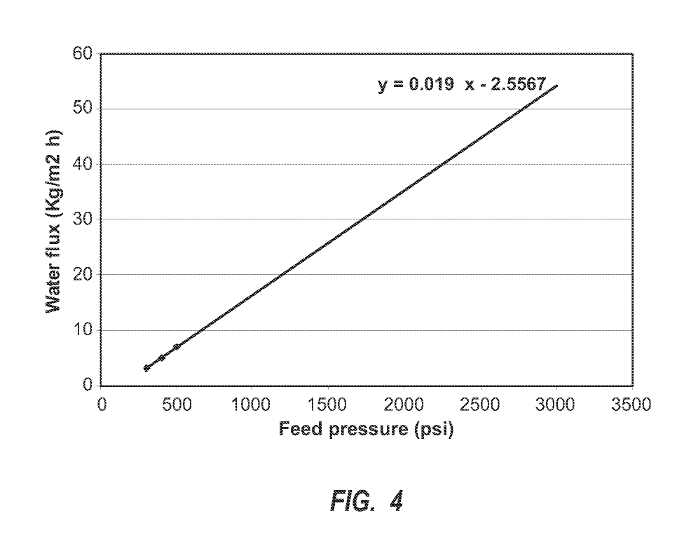

Surprisingly, the flow that can be achieved at these pressures can be quite high. The water flux typically has a linear relationship to the pressure across the membrane. In one embodiment, the water flux is within about 5 Kg/m² of the water flux defined by the equation y=0.019x−2.5567 where y is the water flux in Kg/m² and x is the pressure across the membrane in pounds per square inch. More preferably the flux is within 5.0 Kg/m² of the water flux according to the foregoing equation at a pressure of at least about 200 psi, more preferably at a pressure of at least about 400 psi. Alternatively, the water flux in the foregoing range is within at least about 5.0 Kg/m². FIG. 4 shows a chart illustrating the foregoing relationship between water flux and pressure.

### IV. Examples

### Example 1

### Manufacturing Silicalite-1 Membrane

Example 1 describes a method for manufacturing a silicalite zeolite membrane suitable for use in water desalination. A TPAOH solution (16 g; 15.4%) was added to 8 ml TEOS at 140° C. in a Teflon-lined autoclave. After 24 h, the MFI (silicalite) nanocrystal seeds 150 nm in size were obtained. A suspension (20 g/L) of the zeolite seed particles was prepared by mixing the seed particles with water and adjusting the pH of the solution to 10 using an aqueous NH₃ solution. Adjusting the pH to 10 helped to prevent the seed particles from aggregating together in the suspension.

A coarse glass frit with pore size of 20 μm was used as the support and washed with deionized water under ultrasonic vibration five times and dried at 85° C. The glass frit was then wetted and then immediately coated with the seed suspension by drop-wise addition. Only a small amount of seed suspension was required and the aqueous layer was evaporated quickly leaving only the seed deposit on the glass frit surface. The seed coating step was repeated twice to yield an intermediate supported zeolite.

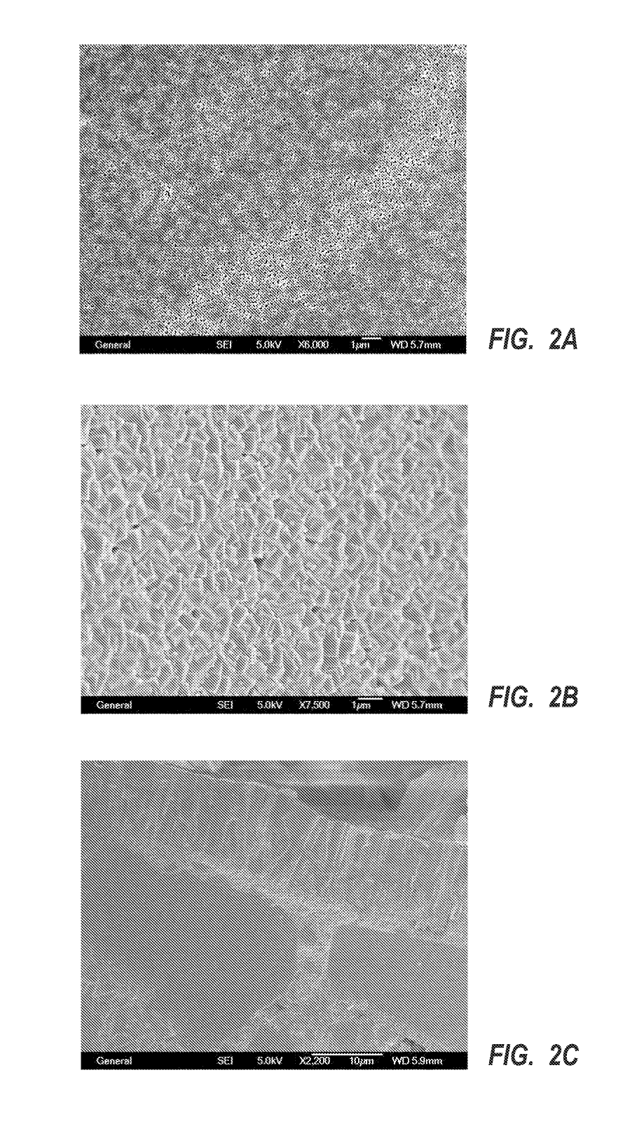

The intermediate supported zeolite was then placed vertically in a Teflon-lined autoclave with a zeolite reaction mixture for secondary zeolite growth. The reaction mixture used was 0.32 TPAOH/1.0 TEOS/165 H₂O and the reaction was carried out at 170° C. for 3 days. The seed crystals grew to form an inter-grown zeolite membrane with a pore structure having a diameter of 0.51 nm. The membranes were then washed with distilled water and dried at 80° C. The membranes were calcined at 550° C. for 8 h to remove organic template. High quality, crack-free tundish zeolite membranes were readily and reproducibly obtained with more than 40% of the membranes showing the desired flux and selectivity. High resolution SEM images of the membranes of Example 1 are shown in FIG. 2A-2C.

### Example 2

### Use of Membranes for Water Desalination

Example 2 describes a method for using the membrane of Example 1 to perform sea water desalination using reverse osmosis. A plurality of membranes manufactured according to the method described in Example 1 were tested using reverse osmosis. The reverse osmosis experiments were conducted at room temperature under standard atmospheric pressure. Solutions containing 3.5% NaCl, KCl, CaCl₂, MgCl₂, were prepared. The filtrate was analyzed using ICP to analyze the ion content. The amount of permeate was measured by weighing the liquid nitrogen cold trap before and after the permeation. Each separation experiment was performed over for 7 to 8 h. After the separation experiment, the membrane was washed with distilled water and dried for future experiments. The separation characteristics can be defined in term of a flux and cation rejection as follows: Flux=P/(S×T), Cation rejection (R)=(C_{feed}−Cₚₑᵣₘₑₐₜₑ)/C_{feed}, where P represents the mount of the permeate (Kg), S the membrane area (m²) and T is a permeation time (h). C_{feed} and Cₚₑᵣₘₑₐₜₑ refer to the ion concentration in the feed and permeate solutions respectively. The results are shown in Table 1 below.

TABLE 1

| Ion type | C_{feed(w %)} | C_{permeate(w %)} | Flux(kgm⁻²h⁻¹) |
|---|---|---|---|
| KCl | 3.5% | 0.0346% | 1.91 |
| NaCl | 3.5% | 0.044% | 2.15 |
| MgCl₂ | 3.5% | 0.011% | 1.94 |
| CaCl₂ | 3.5% | 0.0215% | 1.79 |

### Example 3

### Use of Membrane with Simulated Sea Water

Example 3 describes a method for using the membrane of Example 1 to perform sea water desalination using reverse osmosis. Example 3 was carried out using the same conditions as in Example 2, except that different salt concentrations were used for the feed. Specifically, the salt concentrations in the Feed of Example 3 simulate natural occurring sea water. The results are shown in Table 2.

TABLE 2

| Ion type | C_{feed(w %)} | C_{permeate(w %)} |
|---|---|---|
| NaCl | 2.765% | 0.062% |
| MgCl₂ | 0.336% | 0.0001% |
| Fe₂(SO₄)₃ | 0.2135% | 0 |
| CaSO₄ | 0.14% | 0 |
| KCl | 0.084% | 0.0014% |

### Example 4

### Use of Membrane to Filter NaCl

Example 4 describes a method for using the membrane of Example 1 to perform sea water desalination using reverse osmosis. Example 4 was carried out using the same conditions as in Example 2, except that different concentrations of NaCl were used for the feed. The results are shown in Table 3 below.

TABLE 3

| C_{feed(w %)} | 10% | 3.5% | 2% | 0.5% |
|---|---|---|---|---|
| C_{permeate(w %)} | 0.0187% | 0.044% | 0.0184% | 0.063 |
| Flux(kgm⁻²h⁻¹) | 1.58 | 2.15 | 2.39 | 2.68 |

### Example 5

### Manufacturing ZMS-5 Membrane

Example 5 describes a method for making a ZMS-5 membrane according to the present invention. ZMS-5 seed crystals were prepared using a mixture of 0.1NaOH/1.62TPAOH/6.1TEOS/552H₂O/0.022 Al₂(SO₄)₃.18H₂O. A seed suspension (20 g/L) was prepared by mixing the seed particles with water and adjusting the pH to 10 using an aqueous NH₃ solution to prevent the seed particles from aggregating together in the suspension.

A coarse glass frit with pore size of 20 μm was used as the support and washed with deionized water under ultrasonic vibration five times and dried at 85° C. The glass frit was then wetted and then immediately coated with the seed suspension by drop-wise addition. Only a small amount of seed suspension was required and the aqueous layer was evaporated quickly leaving only the seed deposit on the glass frit surface. The seed coating step was repeated twice to yield an intermediate supported zeolite.

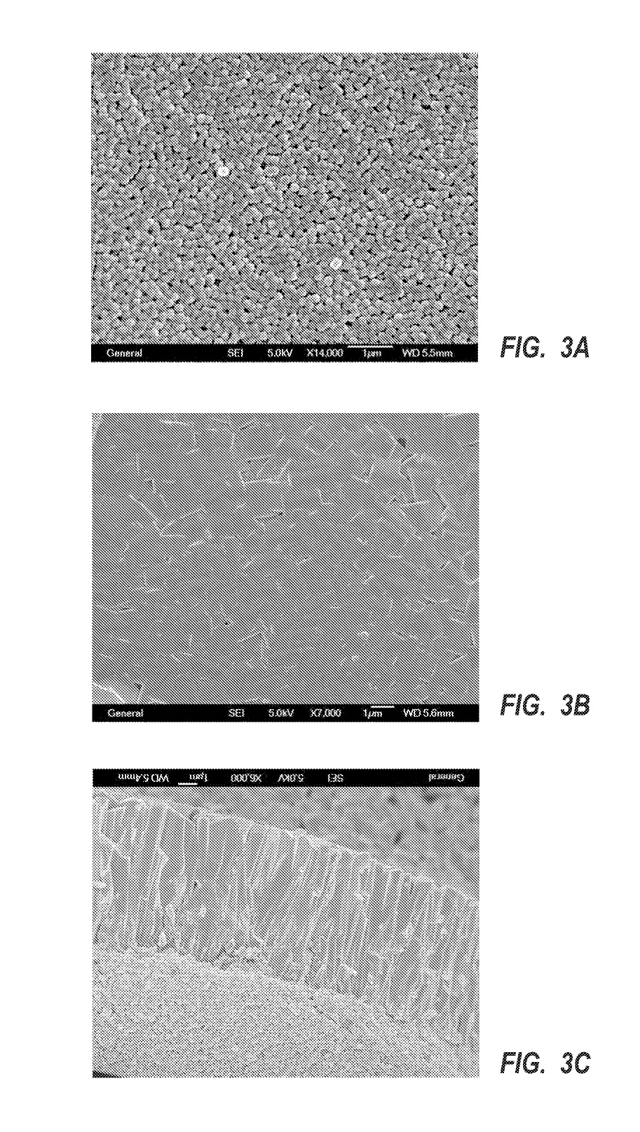

The intermediate supported zeolite was then placed vertically in a Teflon-lined autoclave with a zeolite reaction mixture for secondary zeolite growth. The reaction mixture used was 0.1NaOH/1.62TPAOH/6.1TEOS/552H₂O/0.022 Al₂(SO₄)₃.18H₂O, with a ratio of silica to alumina of 200. The membranes were then washed with distilled water and dried at 80° C. The membrane was calcined at 550° C. for 8 h to remove organic template. High quality, crack-free tundish zeolite membranes were readily and reproducibly obtained with more than 40% membranes showing the desired flux and selectivity. Membranes manufactured according to Example 5 are shown in the high resolution SEM images of FIGS. 3A-3C.

### Example 6

### Use of Membrane with Simulated Sea Water

Example 6 describes a method for using the membrane of Example 5 to perform sea water desalination using reverse osmosis. Example 6 was carried out using the same conditions as in Example 3 (i.e., simulated natural sea water). The results are shown in Table 4.

TABLE 4

| Ion type | C_{feed(w %)} | C_{permeate(w %)} |
|---|---|---|
| NaCl | 2.765% | 0.31162% |
| MgCl2 | 0.336% | 0.0336% |
| Fe₂ (SO₄)₃ | 0.2135% | 0.002776% |
| CaSO₄ | 0.14% | 0.00238% |
| KCl | 0.084% | 0.006384% |

### Example 7

### Use of Membrane with Simulated Sea Water

Example 7 describes a method for using a membrane similar to Example 5 to perform sea water desalination using reverse osmosis. The membrane was manufactured the same as in Example 5, except that 0.11Al₂(SO₄)₃.18H₂O was used (i.e., a silica to alumina ratio of 100). Example 7 was carried out using the same conditions as in Example 3. The results are shown in Table 5 below.

TABLE 5

| Ion type | C_{feed(w %)} | C_{permeate(w %)} |
|---|---|---|
| NaCl | 2.765% | 0.567% |
| MgCl2 | 0.336% | 0.047% |
| Fe₂ (SO₄)₃ | 0.2135% | 0.0076 |
| CaSO₄ | 0.14% | 0.0065 |
| KCl | 0.084% | 0.0093% |

The zeolite membranes of the present invention have surprisingly high flux rates and ion rejection rates when used to separate dissolved ions in water by reverse osmosis. As shown in Example 3 and Example 6, almost 98% ion rejection was achieved using simulated sea water as the feed. A relatively high flux rate of 2.15 was also achievable for a single pass of water with a salt concentration of 3.5 (i.e., similar to sea water) under atmospheric pressure.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for desalinating water, comprising:
providing saline water comprising dissolved ions and water;
providing a zeolite membrane comprising a plurality of porous zeolite crystals having a pore diameter in a range from about 3 angstroms to about 8 angstroms, the porous zeolite crystals being supported on a support material, wherein the plurality of porous zeolite crystals are grown together so as to form the zeolite membrane with a pore diameter of less than about 8 angstroms;
performing reverse osmosis on the saline water by forcing the water through the zeolite membrane while retaining at least a portion of the dissolved ions, thereby yielding a concentrated dissolved ion solution on one side of the zeolite membrane and an aqueous permeate on an opposite side of the zeolite membrane with lower dissolved ion concentration than the saline water.

2. A method as in claim 1, wherein the reverse osmosis is performed at a pressure in a range from about atmospheric pressure to about 5000 kPa.

3. A method as in claim 1, wherein the reverse osmosis is performed at a pressure in a range from about 100 kPa to about 1000 kPa.

4. A method as in claim 1, wherein during the reverse osmosis, the water forced through the zeolite membrane has a flux greater than about 1 kgm⁻²h⁻¹.

5. A method as in claim 1, wherein during the reverse osmosis, the water forced through the zeolite membrane has a flux is greater than about 1.5 kgm⁻²h⁻¹.

6. A method as in claim 1, wherein the saline water comprises sea water.

7. A method as in claim 1, wherein the saline water comprises brackish water.

8. A method as in claim 1, wherein the saline water has an anion concentration in a range between 1% and 8% by weight.

9. A method as in claim 8, wherein the aqueous permeate has an anion concentration of less than 3% by weight.

10. A method as in claim 8, wherein the aqueous permeate has an anion concentration of less than about 2% by weight.

11. A method as in claim 1, wherein the zeolite membrane comprises a zeolite layer formed on the support material.

12. A method as in claim 11, wherein the zeolite membrane has a thickness in a range of about 1 mm to about 20 mm.

13. A method as in claim 11, wherein the zeolite layer has a thickness in a range of about 1 micron to about 300 mm.

14. A method as in claim 11, wherein the zeolite layer has a thickness in a range of about 10 microns to about 200 mm.

15. A method as in claim 11, wherein the zeolite layer has a thickness in a range of about 15 microns to about 100 mm.

16. A method as in claim 11, wherein the zeolite layer comprises has a molar ratio of silica to alumina in a range of about 10 to about 500.

17. A method as in claim 11, wherein the zeolite layer comprises has a molar ratio of silica to alumina in a range of about 50 to about 400.

18. A method as in claim 11, wherein the zeolite layer comprises has a molar ratio of silica to alumina in a range of about 100 to about 300.

19. A method as in claim 11, wherein the support material comprises a glass frit, stainless-steel-net, a-Al₂O₃, a copper net, or a combination thereof.

20. A method as in claim 19, wherein the support material has a pore diameter in a range from about 1 micron to about 100 microns.

21. A method as in claim 1, wherein the porous zeolite crystals are selected from the group consisting of silicalite-1, ZSM-5, zeolite A, zeolite P, zeolite SPO₃₄, and combinations thereof.

22. A method as in claim 1, wherein the porous zeolite crystals are formed from zeolite seed particles having a size in a range from about 20 nm to about 500 nm.

23. A method as in claim 1, wherein the zeolite membrane is comprised of inter-grown zeolite crystals having a diameter in a range from about 20 nm to about 500 nm.

24. A method as in claim 23, wherein the inter-grown zeolite crystals have well-defined crystal boundaries.

25. A method as in claim 1, wherein the zeolite membrane comprises a zeolite layer having a pore diameter in a range from about 3 angstroms to about 8 angstroms.

26. A method as in claim 25, wherein the zeolite layer has a pore diameter in a range from about 4 angstroms to about 7 angstroms.

27. A method as in claim 25, wherein the zeolite layer has a pore diameter in a range from about 4.5 angstroms to about 6 angstroms.

28. A method for desalinating water, comprising:
providing saline water comprising dissolved ions and water;
providing a zeolite membrane comprising a plurality of porous zeolite crystals having a pore diameter in a range from about 3 angstroms to about 8 angstroms, the porous zeolite crystals being supported on a support material, wherein the plurality of porous zeolite crystals are grown together so as to form a zeolite layer on the support material with a pore diameter of less than about 8 angstroms;
performing reverse osmosis on the saline water by forcing the water through the zeolite membrane at a flux greater than about 1 kgm⁻²h⁻¹ while retaining at least a portion of the dissolved ions, thereby yielding a concentrated dissolved ion solution on one side of the zeolite membrane and an aqueous permeate on an opposite side of the zeolite membrane with lower dissolved ion concentration than the saline water.

29. A method for desalinating water, comprising:
providing at least one of brackish or sea water comprising dissolved ions and water, the dissolved ions comprising anions in a concentration range of about 1% to about 8% by weight of the brackish or sea water;
providing a zeolite membrane comprising a plurality of porous zeolite crystals having a pore diameter in a range from about 4 angstroms to about 7 angstroms, the porous zeolite crystals being supported on a support material, wherein the plurality of porous zeolite crystals are grown together so as to form a zeolite layer on the support material;
performing reverse osmosis on the saline water by forcing the water through the zeolite membrane at a flux greater than about 1 kgm⁻²h⁻¹ while retaining at least a portion of the dissolved ions, thereby yielding a concentrated dissolved ion solution on one side of the zeolite membrane and an aqueous permeate on an opposite side of the zeolite membrane with lower dissolved ion concentration than the saline water.
